(19) United States
(12) Patent Application Publication
(10) Pub. No.: US 2004/0157184 A1
(43) Pub. Date: Aug. 12, 2004

(54) Orthodontic bracket and method of attaching orthodontic brackets to teeth

(76) Inventor: Brian C. Reising, Atlanta, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/749,918

(22) Filed: Dec. 31, 2003

Related U.S. Application Data
(60) Provisional application No. 60/437,546, filed on Dec. 31, 2002.

(51) Int. Cl. A61C 3/00

(52) U.S. Cl. 433/8; 433/24

(57) ABSTRACT

An orthodontic bracket having an opening for receiving a wire, but without a base or other part to create a lever arm when the bracket is angled relative to a tooth surface. The bracket can be embedded into and encapsulated by an adhesive that is bonded to the tooth to create a low profile attachment. A clip is provided for holding the bracket in position and occluding the opening while the adhesive is applied. And an indirect method of attaching the brackets to teeth is provided wherein the brackets can be attached to the lingual side of the teeth in a low profile arrangement.

### CROSS-REFERENCE TO RELATED APPLICATION

This application claims the priority benefit of U.S. Provisional Patent Application Ser. No. 60/437,546, filed Dec. 31, 2002, the entire scope and content of which is hereby incorporated herein by reference.

### TECHNICAL FIELD

The present invention relates generally to dentistry and orthodontics and, in particular, to attaching orthodontic brackets to teeth for repositioning the teeth.

### BACKGROUND OF THE INVENTION

Orthodontists commonly correct the position of mal-occluded and mal-aligned teeth by therapeutic tooth movement. Therapeutic tooth movement is accomplished by the application of force to teeth to reposition them. Many orthodontic appliances have been used to apply force to teeth. The most commonly used orthodontic appliance for tooth movement is commonly known as the “edgewise appliance” or more specifically the “fixed pre-adjusted edgewise appliance”— also known as the “straight-wire appliance.” The name “edgewise” refers to the general mechanism of a rectangular slot engaged by a force-generating rectangular wire. The terms “straight-wire”, “pre-adjusted”, and “pre-programmed” refer to an elective, though highly desirable, feature of an edgewise appliance system that will be described as follows.

An edgewise appliance system is a combination of many individual pieces designed to function in a coordinated fashion. The two primary components are tooth “attachments” that are attached to the teeth and “arch-wires” that engage the attachments. The attachments (brackets or bands) are semi-permanently and rigidly attached to the teeth. Typically, the attachments are fabricated of stainless steel, porcelain (ceramic), plastic, or combinations of these materials. The attachments serve as a standardized “handle” by which the tooth may be engaged by a force.

Each attachment in a system (generally referred to as a “bracket”) possesses a rectangular slot that receives the arch-wire component. Typically, all the attachments of a particular system will have the same rectangular slot dimensions of about 0.018×0.025 inches, 0.020×0.025 inches or 0.022×0.025 inches. Some operators prefer to use a combination of various size slots. The slot shape is rectangular to accommodate a wire with a rectangular or square cross section, which permits application of forces and hence control of tooth position in three dimensions.

Typically, arch-wires are made of metal alloys capable of varying degrees of elastic deflections depending on their size, cross-sectional shape, and composition. The elastic deflections in the arch-wire generate forces on the brackets, which in turn translate the forces to the teeth, thereby causing the teeth to move to a desired position.

The human teeth are arranged spatially in the upper or lower jaw (the maxillary or mandibular dental arches respectively) in the shape of an arch with their long axes generally perpendicular to the plane of the arch. The precise shape of the arch varies among individuals from more U-shaped arches to V-shaped arches to parabolic arch forms. The precise shape of any particular arch can vary substantially.

Given that the teeth are naturally arranged in this relatively flat-plane arch-form, it is commonly recognized as an objective of orthodontic therapy that this plane should be made relatively flat and that the teeth should be aligned precisely to form an arch-form shape that is similar (but improved) to the pre-existing condition of the dentition. To serve this objective, the “straight-wire”, “pre-adjusted”, or “pre-programmed” concept of appliance design was derived as a means of executing orthodontic therapy with greater ease, efficiency, and quality. The basic concept of “straight-wire” is that, if the objective of orthodontic therapy is to position teeth in a flat plane, then the force generated by elastic deformations in a flat, straight wire shaped in the form of an arch is an ideal mechanism for producing those results. In theory, the attachments are rigidly fixed to teeth at a precise “pre-adjusted”or “pre-programmed” position on the mid-facial or lingual aspect of a tooth at their respective mal-aligned state. A straight (flat) arch-shaped wire is then deflected to engage the mal-aligned attachments slots. The force generated by the elastic deformation of the wire then “pulls” the teeth along with it as it moves back towards its original shape. The attachment position on each tooth then determines the ultimate and final relative position of each tooth relative to the other teeth upon achievement of the “straight-wire” condition (the theoretical end-point).

Traditionally, the vast majority of orthodontic therapy has been performed with attachment slots placed primarily on the facial aspect of the teeth. It can be readily deduced via casual observation of an arch of teeth that the mid-facial aspects of an arch of teeth tend to align in a straight, flat arch form. However, it is also readily observed upon closer inspection that these mid-facial surfaces do not exactly line up in a straight line with their long axes residing at identical orientations. In fact, one can readily observed consistent deviations in the spatial relations of an arch of tooth crowns and roots. Each tooth type tends to deviate in a specific consistent “average” way relative to the horizontal plane. As such, early pioneers of appliance design theorized that compensations in bracket slot orientation relative to the bracket base could automatically compensate for these differences.

They also realized that the anatomy among types of teeth (upper right central incisor, versus, for instance, an upper right canine, etc.) varies substantially. But because this anatomy is consistent among different individuals for each tooth type, each tooth type, therefore, could receive its own uniquely shaped “average” bracket slot and base orientation. This pre-defined shape can theoretically be used on a particular tooth type for any particular individual. Thus, while the general shape of a bracket system might be very similar, for each particular tooth type the corresponding bracket is designed with specific compensations in base shape, base size, general shape, slot angulation, base thickness, etc. to accommodate differences in tooth type anatomy and tooth type spatial relations relative to the horizontal plane.

The intention of these design specifications was to create a universally applicable appliance that will, if brackets positions are accurately coordinated, create an ideal alignment of teeth if a straight wire is deflected into each slot and if the wire is subsequently permitted to express its original straight shape. By doing so, the operator would possess a pre-programmed mechanical system. Having realized a truly pre-programmed system, theoretically, the operator could eliminate the need for manual manipulation of the system (via the placement of compensating bends in the arch-wire component) and thus produce a highly predictable and efficient outcome.

However, as mentioned, the efficient utilization of a so-called straight-wire appliance depends largely on the orthodontist's ability to coordinate the position of the brackets on mal-aligned teeth so that the forces imposed by deflections of the resilient, straight, arch-wire will result in perfect three-dimensional alignment of the teeth. If the brackets are not properly positioned, then the degree of mal-positioning will be reflected as a proportional degree of mal-positioning of the teeth. Correcting these mal-positions would then require the operator to manually manipulate the shape of the arch-wire component via the placement of compensating arch-wire bends. This is recognized as a comparatively laborious, slow, unpredictable, and inefficient method.

Most orthodontists position the brackets on the patient's teeth using a “direct” method. “Direct” refers to the positioning of each bracket on each tooth directly, inside the patient's mouth. But when working directly inside the mouth it is very difficult to visualize precise bracket positioning and extremely cumbersome to utilize measuring instruments for determining vertical position. Because accurate positioning is so difficult, getting the bracket “close enough” is widely regarded as an acceptable compromise. Because precise positioning of an entire arch of brackets is the exception rather than the norm, the result is a huge compromise in treatment quality and efficiency.

To improve the accuracy of bracket positioning in a typical private practice setting, “indirect” positioning methods have been developed. Rather than positioning brackets directly inside the patient's mouth, the brackets are positioned on a three-dimensional model of the patient's teeth, outside the patient's mouth. In this way, improved visualization and the utilization of measuring devices are permitted, so accurate positioning becomes much more simple and attainable. Once the brackets are positioned on the model and rigidly attached, a “transfer tray” is fabricated and utilized to transfer the brackets from the model to the patient's mouth. The tray preserves the brackets position during the transfer. There are a number of known variations of indirect methods, including those described in U.S. Pat. No. 5,971,754 to Sondhi et al. and U.S. Pat. No. 4,952,142 to Nicholson, which are hereby incorporated herein by reference.

There are drawbacks to conventional bracket systems, regardless of the attachment method used. Typical brackets (both facial and lingual types) are composed of two basic structures. The first, a broad, flat base. Second, is a structure(s) protruding perpendicular to the base that forms the “open face” rectangular slot and the “tie-wings” that are used to anchor a disposable ligature that, in turn, maintains engagement of the wire component in the slot.

Generally, with a facial or lingual bracket system, all anterior and premolar brackets are designed with an open-face slot that allows the arch-wire component to be inserted into the slot along a facio-lingual vector. This bracket design requires the presence of tie-wings to engage and maintain engagement of the wire component. Because of the necessity of tie-wings, these brackets must possess a certain degree of structural profile height and shape irregularity that facilitates overall effectiveness and simple operation of the ligature/tie-wing ligation system by the operator.

Generally, with a facial or lingual bracket system, it is also common to use a tube attachment on molar teeth, rather than an open-face-slot bracket design. The tube type of attachment receives the arch-wire component via threading of the wire through the mesial or distal ends of the tube. This type of attachment has the benefit of not requiring the protruding, bulky, irregularly shaped tie-wings that are required of an open-face design. However, their applications are limited to the posterior teeth due to the necessity of threading the wire through the mesial or distal ends. It would be an impractical endeavor to attempt threading an arch shaped wire through an entire dental arch starting from the most distal molar. Not only would the wire initial need to extend into the patients throat but the lack of a continuously consistent degree of curvature of the wire segment would preclude insertion of a wire of significant stiffness. In addition, the closed-face tube attachment precludes the placement of significant arch-wire bends, therefore, it is only practical if the attachment system is positioned with high precision and coordination.

As such, conventional bracket systems are designed to accommodate one bracket per tooth on either the facial or lingual side, but, as a practical matter, not both. They use open-face slots on anterior and most premolar teeth with tube attachments on the molar teeth. Note that many tube attachments designed for molars are also designed with a removable facial wall that allows the tube to be converted into an open-face bracket. Such designs also require the presence of tie-wings to hold the wire in place once the tube is converted to an open-face bracket.

The relatively large flat base characteristic of most conventional brackets serves several purposes. First, the relatively flat base is intended to rest against each tooth parallel to a tangent plane at the center of its mid-facial surface. This allows the operator the opportunity to use the surface of the tooth as a means of reference for establishing the properly coordinated position of each bracket—the operator-simply must fully seat the bracket base against the tooth at its mid-facial surface. Doing so orients the slot at its recommended three-dimensional pre-programmed (pre-coordinated) position. Second, the base serves as the bonding interface for rigid attachment to the tooth. As such, the “tooth-side” of the base generally possesses mechanical retentive features (such as a mesh pad, particle micro-etched surface, laser-etched surface, etc.) that facilitates durable bonding to the tooth by facilitating mechanical inter-locking between an adhesive and the bracket via penetration of the adhesive into the retentive features. Some brackets, depending on their material composition, may also possess a base that bonds chemically to an adhesive. The base is relatively flat and large to provide a sufficient surface area for creating a durable bond to the tooth.

But a base of any substantial length compromises the ability to custom-coordinate positioning of a bracket in particular ways. For example, if the operator desires to place the slot at an alternative facio-lingual angle, the base interferes and creates an undesirable lever arm that necessitates displacement of the slot in an unfavorable way, a greater distance from the tooth surface. As such, to achieve coordination of the remaining bracket slots would require positioning them with an equal degree of off-set away from the tooth surface. Moreover, with the bracket now positioned farther from the tooth, that is, creating a higher, more protruding profile, the bracket is more prominent and protruding so as to physically annoy a patient. And even when the bracket can be positioned with the base flat against the tooth, the width of conventional brackets alone makes them comparably protrusive, when most patients would prefer them to be minimally protrusive.

In addition, because lingual side tooth anatomy is more highly variable among individual tooth types compared with facial side anatomy, using a “base-dependent” positioning system to achieve a “straight-wire” result is even less efficient than the traditional facial bracket system. That is, a “fixed bracket shape with a base” designed for the lingual tooth surface is remarkably less efficient at achieving coordination of slot positions such that a straight wire could then deflect the teeth to the desired positions. Because of this inefficiency, greater effort and greater unpredictability are realized by the operator who attempts to bend arch-wire to compensate for poorly coordinated lingual bracket slots.

If an operator desires the efficiency of a straight wire mechanical system to be used on the lingual side of teeth, this requires the ability to customize slot position for each patient. While this can theoretically be accomplished using a traditional bracket with a base and protruding tie-wings, the degree of protrusion and irregularity of shape (roughness) creates substantial discomfort for the patient. For this reason and others, lingual bracket systems have seen only very limited applications in orthodontics.

In addition, the desirability of adjustability has lead to the predominant use of open-faced slots. In fact, open-faced slots are a practical necessity because of the obvious problem that a wire possessing compensating bends of significant size cannot be threaded through tubes of small cross-section and the obvious problems with insertion of full-length arch-wires through a closed-face bracket system. But with open-faced slots, the arch-wires must be secured, which is conventionally done by using ligature tie-wings. And the tie-wings create a relatively bulky, high profile bracket system and generally result in a highly irregular surface against which lips, cheeks, and tongue will rub and create discomfort.

Because of the cost associated with the vast inventory of brackets required, most operators use a manufacturer-specified shape (not a shape customized to the unique dental anatomy of the patient) for each tooth. Existing brackets do not allow for minimizing the profile and protuberances, which would create a far more comfortable lingual bracket system. The necessity of having tie-wings to engage ligature ties for the purpose of holding the wire engaged in the slot means that uncomfortably large, irregular protuberances are unavoidable.

Accordingly, there is a need for an orthodontic bracket that has a lower profile and smoother contour, can be positioned on the lingual side of the teeth without compromising patient comfort, is less visibly noticeable, and can be positioned with great precision and flexibility. It is to the provision of such an orthodontic bracket and attachment method that the present invention is primarily directed.

### SUMMARY OF THE INVENTION

One aspect of the present invention includes an orthodontic bracket for use with a wire to reposition a tooth. Generally described, the bracket includes a body with an opening that extends the length of the body for receiving the wire in it. The body of the bracket does not have a base with a significant surface area to facilitate use of a direct method of positioning and bonding the bracket to the tooth and thus fixing the position of the opening. Rather, because the bracket does not possess a base, the bracket, as a practical matter, incorporates an indirect method of precise positioning relative to a model tooth's anatomic feartures without any part of the bracket creating a significant lever arm that would cause the bracket to have a higher effective profile. In exemplary embodiments of the bracket, the body has a gingival sidewall, an occlusal sidewall, and a lingual sidewall that together form a slotted opening with the open side facing the tooth. The bracket has a very a low profile with a width that is equal to the depth of the opening plus the thickness of the lingual sidewall.

The bracket can be positioned offset from the model tooth or adjacent to it. When the bracket is offset from the model tooth, then it is suspended by, for example, a positioning instrument that also registers the relevant anatomic features, preferably with no part of the bracket contacting the model tooth. And when the bracket is adjacent to the model tooth, then the gingival sidewall, the occlusal sidewall, or both may contact the model tooth at some point along its length.

Preferably, the opening is rectangular and the bracket can be positioned adjacent to or offset from a generally vertical or non-vertical surface of the model tooth with the rectangular opening precisely positioned spatially at a desired position, and preferably still level. In some embodiments, the occlusal sidewall length is greater than the gingival sidewall length, such that the open tooth side of the opening is angled from vertical.

In addition, the bracket may include one or more retention wings extending from the body for enhanced bonding strength. In these embodiments, the retention wings do not add substantially to the bracket's profile width, and thus, it retains its low profile width with the profile width being effectively equal to the opening depth plus the lingual sidewall thickness. Preferably, the opening is rectangular and the wings are angled relative to the rectangular opening and tooth surface such that the wings do not interfere with its spatial orientation by acting as a lever arm against the tooth. In this way, the bracket can be positioned adjacent to or offset from a vertical or a non-vertical surface of the tooth with the rectangular opening still level. In some embodiments, the wings curve away from the tooth as they extend away from the opening, so that if the wings were extended across the opening they would form a continuous convex surface. For example, in some embodiments for use on back teeth, one of the wings extends from a gingival sidewall of the body and is curved back as the wing extends away from the opening. And another of the wings extends from an occusal sidewall of the body and is curved back as the wing extends away from the opening. But in other embodiments for use on the lingual surface of front teeth, the other wing that extends from an occusal sidewall of the body is curved forward as the wing extends away from the opening.

In alternative embodiments, the bracket has notches or slits that promote enhanced bonding strength, a laterally curved body and opening, two or more of the openings, and/or a tubular opening.

Another aspect of the present invention includes an orthodontic attachment for use with a wire to reposition a tooth. Generally described, the attachment includes a mass of adhesive bonded to the tooth and an orthodontic bracket embedded in the adhesive mass. Preferably, the adhesive mass encapsulates the bracket except for the opening. The adhesive mass and the bracket can be attached to a lingual or facial surface of the tooth. The attachment may include a bracket of the type described herein or another.

Yet another aspect of the present invention includes an orthodontic appliance for repositioning a plurality of teeth. Generally described, the appliance includes a series of orthodontic attachments attached to the teeth and receiving a wire. Preferably, some of the attachments are attached to lingual surfaces of the front teeth. For the back teeth, the appliance attachments may be attached to the lingual or facial tooth surfaces. The appliance may include attachments made using a bracket of the type described herein or another.

Still another aspect of the present invention includes a clip for holding an orthodontic bracket having an opening. Generally described, the clip has a finger that it is received in the bracket opening and a handle portion for grasping. The finger has a length that is equal to or greater than the length of the bracket opening so that the finger extends all the way through the opening to prevent the adhesive from intruding into and blocking the opening. Preferably, the finger is configured so that it fits snugly in the opening. In this way, the clip can be held by the handle portion and the clip will support the bracket. For example, the finger may have a cross sectional shape and a lateral curvature that conform to a cross sectional shape and a lateral curvature of the bracket opening. In addition, the handle portion is preferably keyed for use with a keyed positioning tool, so that the clip can be consistently aligned when grasping it with the positioning tool.

And another aspect of the present invention includes an orthodontic kit comprising a plurality of orthodontic brackets and holding clips. Preferably, the bracket has a body and an opening that are configured for positioning the bracket offset from or adjacent to a tooth in a low profile arrangement. And the clip has a finger for insertion into the opening to hold the bracket and block adhesive from intruding into the opening. The bracket and clip may be of the types described herein or others.

Having described the brackets, attachments, appliances, and clips, another aspect of the present invention providing a method of using of the brackets and the clips to form the attachments and appliances will now be described. Generally described, the method includes the steps of creating a model of the teeth and providing orthodontic brackets with openings for the wire, with the brackets preferably of the type described herein. Next, the method includes the steps of positioning the brackets relative to the model teeth, occluding the bracket openings, bonding the brackets to the model teeth with an adhesive, fabricating a transfer tray by applying an impression material to the model teeth and the brackets, removing the tray containing the impression material and the brackets from the model teeth with the brackets held in position by the impression material, positioning the tray with the brackets on the teeth, bonding the brackets to the teeth with an adhesive, removing the tray from the brackets and teeth, and unoccluding the bracket openings by removing the clips. Upon the completion of the method, the adhesive is bonded to the teeth, preferably using the same adhesive, and the brackets are embedded in the adhesive with the openings unobstructed.

Preferably, the step of positioning the brackets includes, for each of the brackets, providing a clip of the type described herein for holding the bracket and moving the bracket/clip unit until the bracket is positioned. In addition, the step of occluding the bracket opening may include inserting a finger of the clip into the bracket opening, and the step of unoccluding the bracket opening may include removing the finger from the bracket opening. Moreover, the step of positioning the brackets may involve grasping the handle portion of the clip by a positioning tool or machine.

The step of positioning the brackets further includes, for each of the brackets, positioning the bracket offset from or adjacent to the corresponding tooth, as is appropriate for that particular tooth. This step may also include positioning some of the brackets at the lingual surfaces of the front teeth and positioning some of the brackets at the facial surfaces of the back in an overlapping arrangement.

In addition, preferably, the steps of bonding the brackets to the model teeth and forming the transfer tray includes a means of creating a smooth adhesive mass that encapsulates the brackets except for the slot openings. For example, adhesive can be added to the model and bracket to create the adhesive mass and then the transfer tray can be formed around this adhesive mass using preferred impressions materials. Or, for example, instead of forming the entire adhesive mass by adding adhesive to the model, a void can be created in the impression material by adding a prior shell that surrounds the bracket and clip unit in a preferred way. The adhesive mass then is formed in a subsequent step immediately prior to inserting the transfer tray inside the patients mouth where the adhesive is added to the void to over-fill it slightly such that the adhesive both forms the completed, smooth surface attachment delimited by the shell and simultaneously bonds the bracket to the tooth.

Accordingly, the present invention provides orthodontic brackets that have a minimal size profile to enhance patient comfort and than can be placed on the lingual side of teeth to minimize visibility and at the same time are extremely flexible in the positions in which they can be oriented to form orthodontic attachments and appliances. Because of this flexibility, the brackets and methods of attachment can be used to reposition teeth much more quickly and with much less patient discomfort while minimizing visibility of the appliances.

The specific techniques and structures employed by the invention to improve over the drawbacks of the prior devices and accomplish the advantages described herein will become apparent from the following detailed description of the exemplary embodiments of the invention and the appended drawings and claims.

### BRIEF DESCRIPTION OF THE DRAWINGS

FIG. 1A is a side view of a prior art orthodontic bracket.

FIG. 1B is a side view of the prior art orthodontic bracket of FIG. 1, showing the limitation on rotational positioning of the bracket.

FIG. 1C is a side view of the prior art orthodontic bracket of FIG. 1, showing the limitation on in/out positioning of the bracket.

FIG. 2 is a perspective view of an orthodontic bracket according to a first exemplary embodiment of the present invention, showing an opening for an arch-wire and wings for bonding strength.

FIG. 3 is a side view of an orthodontic attachment including the orthodontic bracket of FIG. 2 attached to the lingual surface of an incisor tooth.

FIG. 4 is a side view of an orthodontic attachment including the orthodontic bracket of FIG. 2 attached to the lingual surface of a canine tooth.

FIG. 5A is a perspective view of a first alternative embodiment of the orthodontic bracket of FIG. 2, showing notched edges in the wings.

FIG. 5B is a perspective view of a second alternative embodiment of the orthodontic bracket of FIG. 2, showing the bracket body and opening being laterally curved.

FIG. 5C is a side view of a third alternative embodiment of the orthodontic bracket of FIG. 2, showing the bracket body having two arch-wire openings.

FIG. 5D is a side view of a fourth alternative embodiment of the orthodontic bracket of FIG. 2, showing the bracket without wings.

FIG. 5E is a side view of a fifth alternative embodiment of the orthodontic bracket of FIG. 2, showing the bracket having a tubular opening.

FIG. 6 is a side view of an orthodontic bracket according to a second exemplary embodiment, showing wings swept back on both sides.

FIG. 7 is a side view of an orthodontic attachment including the orthodontic bracket of FIG. 6 attached to a generally vertical surface of a molar tooth.

FIG. 8 is a side view of an orthodontic attachment including the orthodontic bracket of FIG. 6 attached to a sloped surface of a molar tooth.

FIG. 9 is a side view of a first alternative embodiment of the orthodontic bracket of FIG. 6, showing the bracket body having two arch-wire openings.

FIG. 10 is a side view of an orthodontic attachment including the orthodontic bracket of FIG. 9 attached to a surface of a molar tooth.

FIG. 11 is a plan view of an arch of teeth showing an orthodontic appliance including six of the attachments of FIG. 2 on lingual surfaces of front teeth and two sets of five of the attachments of FIG. 6 on facial surfaces of back teeth.

FIG. 12 is a plan view of an arch of teeth showing an orthodontic appliance including eight of the attachments of FIG. 2 on lingual surfaces of front teeth and two sets of four of the attachments of FIG. 6 on facial surfaces of back teeth.

FIG. 13 is a plan view of an arch of teeth showing an orthodontic appliance including ten of the attachments of FIG. 2 on lingual surfaces of front teeth and two sets of three of the attachments of FIG. 6 on facial surfaces of back teeth.

FIG. 14 is a plan view of an arch of teeth showing an orthodontic appliance including the attachments of FIGS. 2 and 6 on lingual surfaces of front and back teeth and including the attachments of FIG. 5C or 7 on lingual surfaces of intermediate teeth.

FIG. 15 is a plan view of a clip according to an exemplary embodiment of the present invention, for holding the bracket of FIG. 2.

FIG. 16 is a side view of the clip of FIG. 15.

FIG. 17 is a plan view of the clip of FIG. 15 holding the bracket of FIG. 2, showing a clip finger received in the bracket opening.

FIG. 18 is a side view of the bracket of FIG. 2 being positioned on model teeth, with the bracket held by the clip of FIG. 15, which is held by a positioning tool.

FIG. 19 is a side view of the bracket of FIG. 2 encapsulated and bonded to the model teeth.

FIG. 20 is a side view of an impression being made of-the model teeth, bracket, and encapsulation.

FIG. 21 is a side view of the impression, bracket, and encapsulation removed from the model teeth.

FIG. 22 is a side view of the impression, bracket, and encapsulation positioned on the patient's teeth from which the model teeth were made.

FIG. 23 is a side view of a completed orthodontic attachment with the adhesive material encapsulating the bracket and the opening unobstructed.

FIG. 24 is a side view of the bracket of FIG. 2 bonded to the model teeth and alternatively encapsulated by being covered with a shell.

FIG. 25 is a side view of an alternative completed orthodontic attachment with the bracket embedded into but not encapsulated by the adhesive material.

### DETAILED DESCRIPTION OF EXEMPLARY EMBODIMENTS

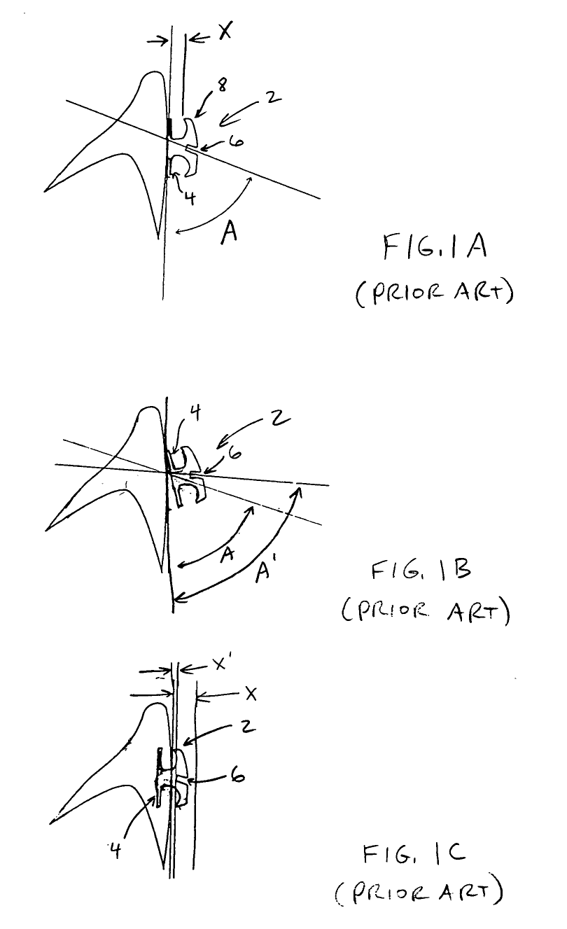

Referring to the drawings, FIGS. 1A-C illustrate a conventional prior art orthodontic bracket 2. The bracket has a flat base 4 with a large surface area for bonding to a tooth, a rectangular slot 6 for a rectangular wire, and tie wings 8 for tying down the wire in the slot. Once the base 4 is positioned against the tooth, the orientation and position of the slot 6 are fixed and cannot be easily customized. In particular, the bracket 2 cannot be easily rotated to adjust the angle A of the slot 6 relative to the tooth, for example, to an increased angle A′, without the base 4 acting as a lever arm that increases the in/out position of the slot relative to the tooth (see FIG. 1B). And the bracket 2 cannot be moved horizontally to adjust the in/out position X of the slot 6 relative to the tooth, for example, to a decreased in/out position X′, because of interference with the tooth (see FIG. 1C). As such, the bracket slot 6 is offset a good distance from the tooth surface, giving the bracket a relatively high profile and making it somewhat uncomfortable for the patient. And because the bracket depends upon the regularity of the facial tooth surface for its proper orientation, the bracket can only be used practically on the facial surfaces of front teeth.

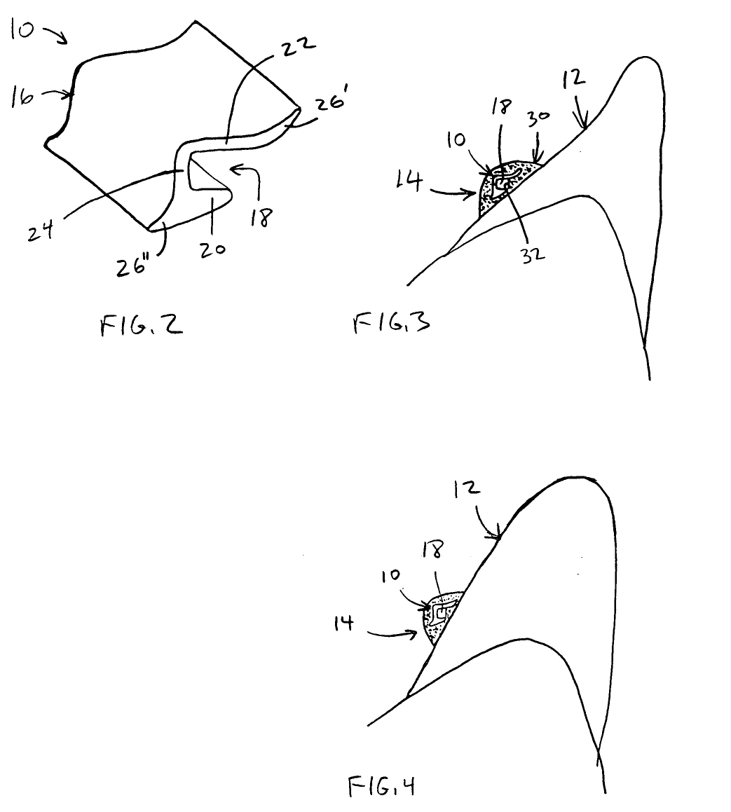

Referring now FIGS. 2-4, there is illustrated an orthodontic bracket 10 according to a first exemplary embodiment of the present invention. The bracket 10 is positioned relative to a tooth 12 and used to form an orthodontic attachment 14 that receives an arch-wire (not shown) to reposition the tooth 12. In a typical commercial embodiment, the bracket 10 is used with arch-wire that is of a maximum cross-sectional dimension of 0.014×0.022 inch rectangular metal wire. As used herein, the terms “arch-wire” and “wire” mean any elongated force-imparting member that may be used with orthodontic attachments for repositioning teeth. Accordingly, the wire may be circular, have another shape, be larger or smaller, and/or may be made of plastic or another material. In addition, a typical commercial embodiment of the bracket 10 is made of metal by forging, casting, or other techniques. It will be understood, however, that other fabrication techniques and materials may be used, such as plastics, ceramics, carbon fiber materials, and composites. Furthermore, the bracket 10 is primarily, though not exclusively, for use on the lingual surface of incisors and other front teeth, while other-described embodiments are primarily for use on molars and other back teeth.

The bracket 10 has a body 16 with an opening 18 for receiving the wire in it. The opening 16 is coextensive with the body 14, that is, it extends the length of the body so that the opening is open at both ends of the body. Preferably, the body 16 has a gingival sidewall 20, an occlusal sidewall 22, and a lingual sidewall 24 that together form the opening 18 as a rectangular slot with its open side facing the tooth 12. In typical commercial embodiments, the bracket 10 is provided in lengths of 1.5 mm and 3 mm, for use on different-sized teeth, and the opening 18 is rectangular with a cross section dimension of 0.016×0.024 inch. It will be understood, however, that other sizes and shapes of bodies and openings can be provided. For example, the opening may be of a cross-sectional shape that is circular, semi-circular, ovoid, or other, and/or of a closed tube design. It is understood that the rectangular shape reflects an embodiment currently preferred by most practitioners and that its purpose, to engage a force in three dimensions, may be realized by alternative shapes.

The body 16 of the bracket 10 does not have a flat (or other shaped) base with a broad surface area for bonding directly to the tooth and fixing the position of the opening, as do conventional brackets. Instead, the bracket 10 can be positioned with the opening 18 at an angle relative to the tooth surface 12 without any part of the body 16 creating a lever arm against the tooth surface. In this way, the bracket 10 can be oriented in a wide range of positions while maintaining a low profile and low visibility.

In addition, the bracket body 16 preferably includes retention wings 26a and 26b (collectively, the “wings 26”) extending from it. The wings 26 serve to distribute forces imposed upon the bracket over a larger area of the adhesive component such that stresses will be less concentrated in any particular area of the adhesive thus improving the overall integrity of the attachment structure. These wings 26 extend away from the tooth surface so as to avoid creating a lever arm against the tooth surface and increasing the in/out position of the opening 18. In this configuration, the bracket 10 retains its low profile, with its width being equal to the depth of the opening 18 plus the thickness of the lingual sidewall 24 plus the horizontal extension of the wings 26.

Preferably, the wings 26 are angled relative to the rectangular opening 18 so that the bracket 10 can be positioned adjacent to or offset from a vertical or a non-vertical surface of the tooth 12 with the rectangular opening still level. More particularly, in a typical commercial embodiment, the wings 26 curve away from the tooth 12 as they extend away from the opening 18, so that if the wings were extended across the opening they would form a continuous convex surface. For example, because the bracket 10 is primarily for use on the lingual surface of incisors and other front teeth, the gingival wing 26b extends from the gingival sidewall 20 of the body and is curved back as it extends away from the opening 18. And the occlusal wing 26a extends from the occusal sidewall 22 of the body and is curved forward as the wing extends away from the opening 18.

In addition, the occlusal sidewall length is preferably greater than the gingival sidewall length, so that the open side of the opening 18 is angled from vertical. In this preferred configuration, the bracket 10 has an extremely low profile that is not compromised by adjusting its position to get the opening 18 into a desired position.

Referring particularly to FIGS. 3 and 4, the bracket 10 can be used to form the low profile orthodontic attachment 14 on different angled surfaces of teeth 12. When forming the attachment 14, the bracket 10 can be positioned offset from or adjacent to a vertical or a non-vertical surface of the tooth 12, with the rectangular opening 18 still level. When the bracket 10 is offset from the tooth 12, then the bracket is suspended with no part of the bracket contacting the tooth. And when the bracket 10 is adjacent to the tooth 12, then the gingival sidewall 20, the occlusal sidewall 22, or both contact the tooth. For example, when the bracket 10 is used to form an attachment 14 on the lingual surface of the incisor tooth 12 of FIG. 3, the gingival sidewall 20 is adjacent to the tooth and the occlusal sidewall 22 is offset from the tooth. But when the bracket 10 is used to form an attachment 14 on the more vertically sloped lingual surface of the canine tooth 12 of FIG. 4, the occlusal sidewall 20 is adjacent to the tooth and the gingival sidewall 22 is offset from the tooth. And in both cases, the rectangular opening 18 is oriented level, that is, squared to horizontal and vertical, and positioned spatially in an ideal way for coordination with the adjacent brackets so that their openings (and thus the arch-wire that is later inserted into the openings) form a continuous and smooth arch. Furthermore, this flexibility permits using the same type of bracket 10 on other-sloped tooth surfaces, including at higher or lower positions of the same tooth and on different teeth. Details of the preferred methods of using the bracket 10 to form the attachment are provided below.

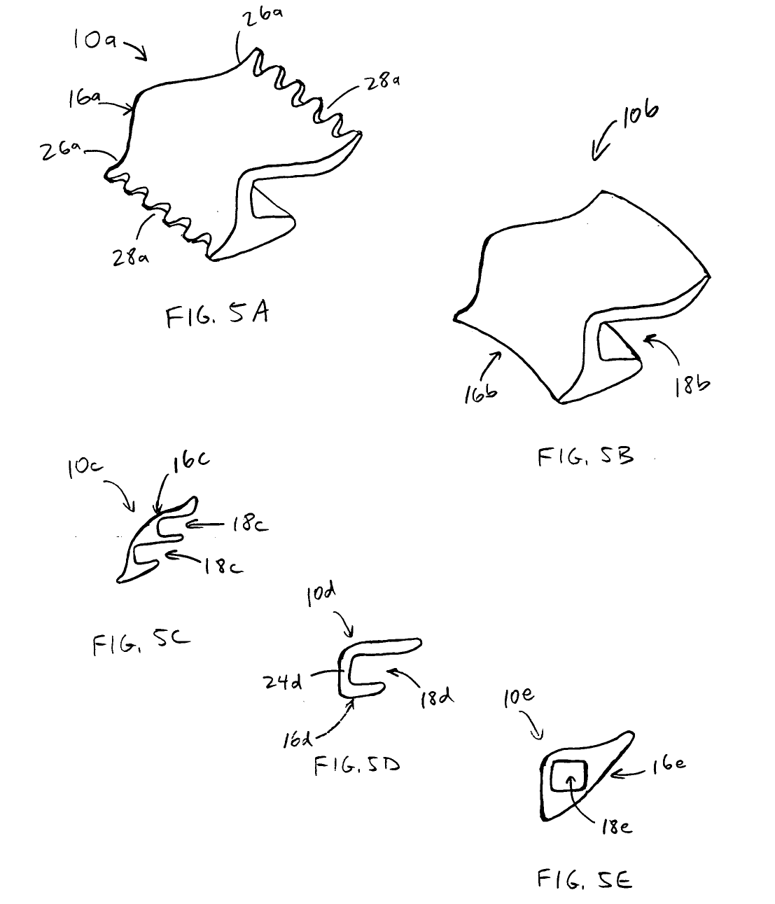

Referring to FIGS. 5A-E, there are shown several of the possible alternative embodiments of the bracket 10. FIG. 5A shows a bracket 10a according to a first alternative embodiment, in which the wings 26a of the body 16a have notches 28a. The notches 28a reduce the tendency of fracture planes forming in the bonding material, thereby providing increased bonding strength. Towards this end, the notches can be deeper or shallower, greater or lesser in number, and/or made in a curved, triangular, squared, or other shape, as may be desired.

FIG. 5B shows a bracket 10b according to a second alternative embodiment, in which the bracket body 16b and opening 18b are laterally curved. In this configuration, the curved opening 18b more closely conforms to the curvature of the arch of the teeth, which defines the curvature of the arch-wire. Thus, when the wire is installed in the opening 18b, it can curve slightly so that it does not need such a sharp bend upon exiting the opening at its ends. And the curved body can be rotated slightly at the mesial or distal end (about a vertical axis) to orient the opening while maintaining a low profile.

FIG. 5C shows a bracket 10c according to a third alternative embodiment, in which the bracket body 16c has two openings 18c. In this configuration, the bracket 10c can be used to form attachments that make up a sectionalized orthodontic appliance that accommodates the insertion of multiple wire segments, as will be described in more detail below.

FIG. 5D shows a bracket 10d according to a fourth alternative embodiment, in which the bracket body 16d has no wings. In this configuration, the bracket 10d has a low profile, with a width that is equal to the depth of the opening 18d plus the thickness of the distal sidewall 24d.

FIG. 5E shows a bracket 10e according to a fifth alternative embodiment, in which the bracket opening 18e is tubular and the bracket body 16e has four sidewalls defining the tubular opening. In this configuration, there is more bracket body surface area for bonding and a grasping clip can be more easily removed from the opening because the adhesive does not contact it. But the bracket 10e may not be quite as low in profile and may be more costly to manufacture. Accordingly, instead of the tubular opening 18e being completely closed, the fourth (tooth-side) sidewall may be thin and extend across the opening from the occusal side but stop short of the gingival side (leaving a gap), thereby eliminating the width that would otherwise be added by the fourth sidewall.

In another alternative embodiment, the bracket body has one or more inner flanges for assisting in holding the bracket on a grasping clip. In yet another alternative embodiment, the bracket body has a lingual sidewall and gripping arms extending from opposite ends of it that together define the opening, with the gripping arms configured for holding the bracket on a grasping clip. In still another alternative embodiment, the bracket body is generally L-shaped and rests on a grasping clip, with or without gripping arms. In another alternative embodiment, the bracket body is generally triangular-shaped with the opening in the long side. In yet other alternative embodiments, the bracket has two openings that are aligned but with a gap between them, that are vertically overlapping and laterally staggered, or that are stacked horizontally. And in still another alternative embodiment, the bracket opening is at the gingival, occusal, or lingual side of the bracket body.

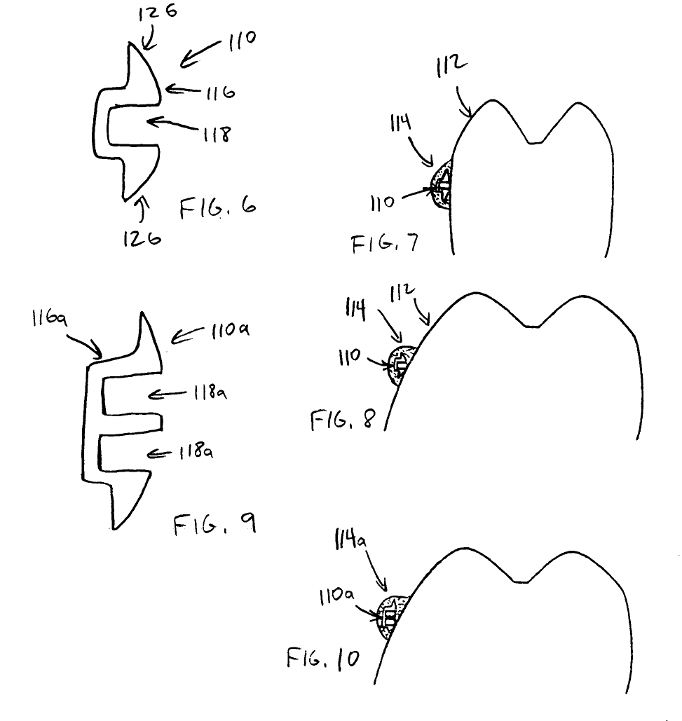

Referring to FIGS. 6-8, there is shown an orthodontic bracket 110 according to a second exemplary embodiment of the present invention. While the bracket 10 of the first exemplary embodiment is primarily for use on the lingual surface of incisors and other front teeth 12, the bracket 110 of the second exemplary embodiment is primarily, but not exclusively, for use on the facial or lingual surfaces of molars and other back teeth 112. Because these surfaces are generally much closer to vertical than the lingual surfaces of incisors where the brackets 10 are attached, the bracket 110 has an opening 118 and wings 126 that are configured differently.

In particular, the opposing sidewalls that form the opening 118 have the same length, or about the same. And both the wings 126 are swept back so that they curve back symmetrically as they extend away from the opening 118. In this configuration, the bracket 110 can be positioned in a wide range of low profile positions. For example, FIG. 7 shows an orthodontic attachment 114 with the bracket 110 positioned adjacent a generally vertical surface of a premolar tooth 112, and FIG. 8 shows that same bracket positioned adjacent to a sloped surface of a molar tooth. In both cases, the bracket 110 and resulting attachment 114 are low profile, with the rectangular opening 118 still level and at a preferred spatial orientation.

FIGS. 9 and 10 show a bracket 110a according to a first alternative to the second exemplary embodiment, in which the bracket body 116a has two openings 118a. In this configuration, the bracket 110a can be used to form attachments 114a that make up a sectionalized orthodontic appliance, as will be described in more detail below. It will be understood that the alternative features described above with respect to the first exemplary embodiment can be implemented as alternative embodiments to the second exemplary embodiment.

Referring back to FIG. 3, details of the orthodontic attachment 14 will now be provided. The attachment 14 includes a mass of adhesive 30 bonded to the tooth 12 and an orthodontic bracket 10 bonded within the adhesive mass. The adhesive 30 is preferably provided by a generally white-colored optically curable compound. By using an adhesive 30 with a color and translucency that resemble the color and translucency of teeth, the attachment 14 is less noticeable. Alternatively, the attachment 14 may be formed using other bonding agents.

The bracket 10 is selected for forming the attachment 14 on a lingual or facial surface of the tooth 12, as desired. The attachment 14 is preferably made using one of the brackets 10 or 110 described herein. This way, the bracket 10 can be positioned offset from or adjacent to the tooth 12 while maintaining the desired orientation of the opening 18, so that the profile and visibility of the resulting attachment is minimized. Other types of brackets can be used, but to lesser advantage.

Preferably, the adhesive mass 30 encapsulates the bracket 10, except for the opening 18. In this configuration, the attachment 14 has a nice, smooth, continuous outer surface where the tongue and/cheeks might rub against it. Alternatively, the bracket 10 can be embedded in the adhesive mass 30, but not encapsulated, so that a portion of the body 16 remains exposed. In this configuration, the width of the attachment 14 is minimized. In any case, when using a bracket 10 with a slotted opening 18, the opening has a fourth wall 32 defined by the adhesive mass 30.

Turning now to FIG. 11, there is shown an exemplary embodiment of an orthodontic appliance 34 made from a series of the attachments 14 and 114 mounted on an arch of teeth 12 and 112, with arch-wires 36 routed through the openings of the attachments and secured in placed by, for example, composite stoppers (not shown) at the wire ends and/or at some point between the teeth. The figure shows the teeth 12 and 112 after the appliance 34 has been used to reposition them to their proper positions. When the appliance 34 is initially installed, the attachments 14 and 114 are not so nicely aligned and the wire 36 is not so nicely and smoothly arched. Instead, the initially bent wire 36 imparts forces to the nonaligned attachments 14 and 114, which in turn pushes/pulls the teeth 12 and 112 towards the position in the figure.

In the embodiment shown, the appliance 34 includes six of the attachments 14 on lingual surfaces of the anterior six teeth 12 and two sets of five of the attachments 114 on facial surfaces of posterior teeth 112. In this way, the appliance 34 is sectionalized into two back teeth sections that overlap with one front teeth section to simulate the effect of one continuous, straight wire. In this context, “overlapping” means that more than one the appliance sections are present on a particular tooth, even if the sections each terminate shy of each other (so that a vertical line can not be drawn through them both). Preferably, the front teeth section overlaps with the back teeth sections, as shown, by virtue of at least one tooth (the canine in this example) possessing both facial and lingual attachments. Because the wire sections are disconnected, the aboslute vertical position of each wire section can thus exist independently of the absolute vertical position of the other sections allowing more flexibility in the vertical position of these sections. In other words, bracket positions can be coordinated within each section independently of the other sections, thus, one section may exist at a higher or lower position in relation to the other sections. Also, because the spatial position of the attachments can be highly customized with precision (using a precision positioning instrument), the attachments may be positioned with the higher degree of accuracy required to create a straight-wire system out of disconnected multiple sections of wire.

The appliance 34 is preferably made using the attachments 14 or 114 described herein, so that the appliance has a low profile and is, therefore, not so noticeable. In this way, one or more of the attachments can be formed having their brackets positioned adjacent to their corresponding teeth, and one or more other of the attachments can be formed having their brackets positioned offset from their corresponding teeth, as may be needed to make appliance have a smooth arch-form to minimize the bending needed in the wire. Other types of attachments and brackets can be used, but to lesser advantage.

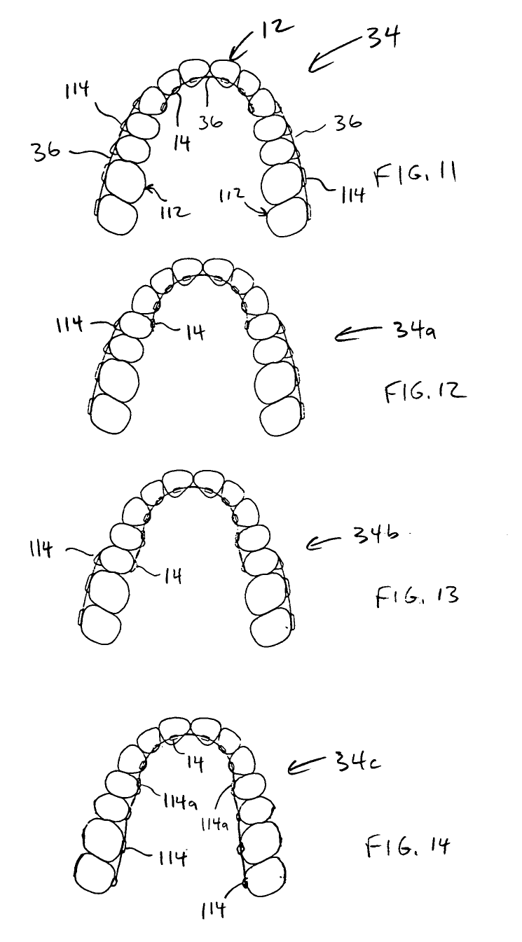

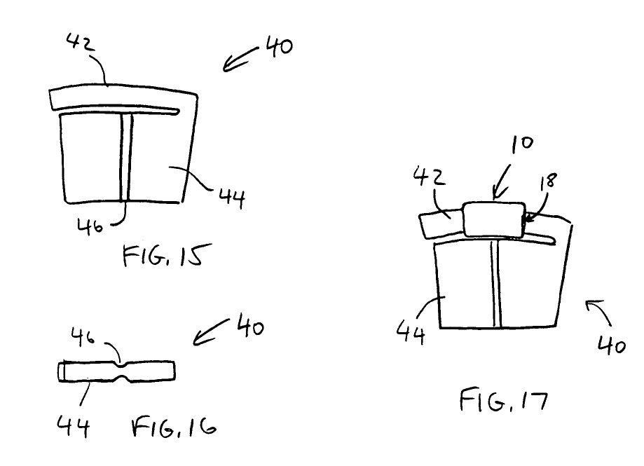

FIG. 12 shows an alternative appliance 34a having three wire sections, the first being eight of the attachments 14 on lingual surfaces of front teeth 12 teeth and two sets of four of the attachments 114 on facial surfaces of back teeth 112. Similarly, FIG. 13 shows another alternative appliance 34b having five sections of wire, ten of the attachments 14 on lingual surfaces of front-most ten teeth 12, two sets of four attachments on the two premolar teeth with two single attachments placed on the lingual of first premolar teeth to serve as the anterior overlap point. Then two sets of three of the attachments 114 on facial surfaces of back teeth 112 including another overlap point on the second premolar which has both facial and lingual attachments. And FIG. 14 shows yet another alternative appliance 34c having various of the attachments all on lingual surfaces of the front and back teeth 12 and 112. In other alternative embodiments, the appliance can be formed using only single-opening attachments, only double-opening attachments, or any combination thereof, on only facial tooth surfaces, only lingual tooth surfaces, or any combination thereof. In other alternative embodiments, the appliance can be configured of as many or few overlapping sections as desired to simulate a continuous straight-wire system. Or the appliance may be configured with any combination of overlapping or non-overlapping sections, with either double- or single-tube attachments. Or, the appliance can be configured with one or multiple non-overlapping sections as deemed appropriate or possible for the achievement of particular objectives in any particular case.

Turning now to FIGS. 15-17, there is shown a grasping clip 40 according to an exemplary embodiment of the present invention. The clip 40 is used to hold the bracket 10 in position while it is being bonded to the tooth or model 12. The clip 40 is intended primarily for use with brackets of the type described herein, though it can be used with other orthodontic brackets to some advantage. The clip 40 is preferably a unitary piece of molded plastic, though it can be made of other materials using other fabrication techniques.

The clip 40 has a finger 42 that it is received in the bracket opening 18 and a handle portion 44 for grasping. The finger 42 has a length that is greater than the length of the bracket opening 18 so that the finger extends all the way through the opening to prevent the adhesive from intruding into and blocking the opening (meaning preventing or hindering the routing of the wire through the opening). In a typical commercial embodiment, the finger 42 has a length that is greater than 3 mm, so that it can be used with brackets up to that length. Preferably, the finger 42 is configured so that it fits snugly in the opening 18. For example, the finger 42 may have a cross sectional shape and a lateral curvature that conform to a cross sectional shape and a lateral curvature of the bracket opening. Thus, for use with the bracket 10b of FIG. 5B, the finger 42 would preferably be rectangular in cross section and laterally curved. In this way, the clip 40 can be held by the handle portion 44 and the clip will support the bracket 10 securely in position so that it doesn't move while it is being bonded to one of the teeth.

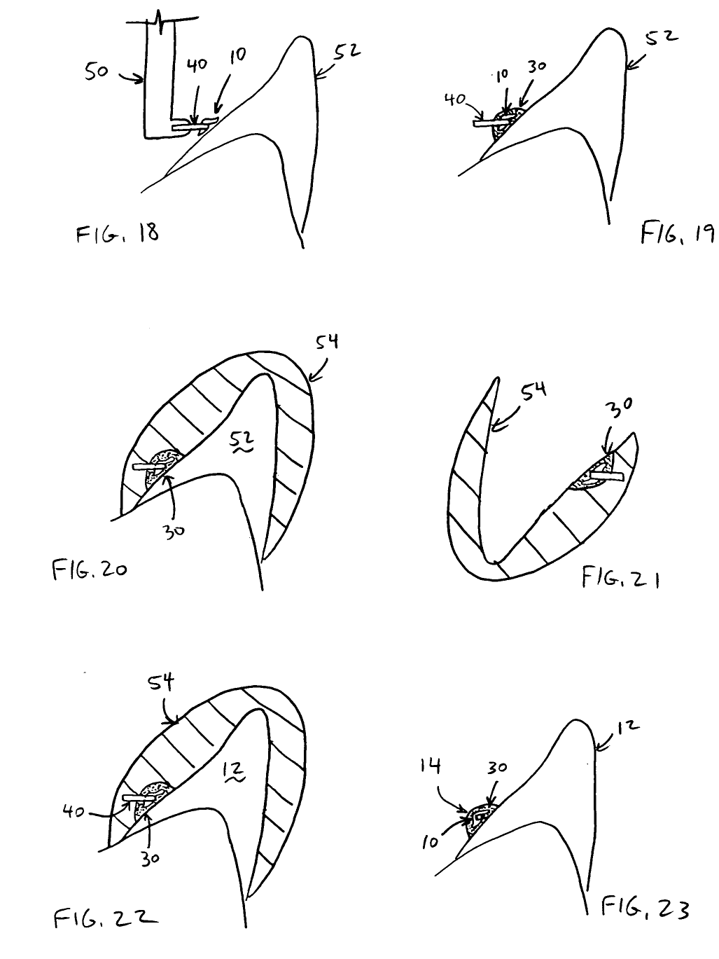

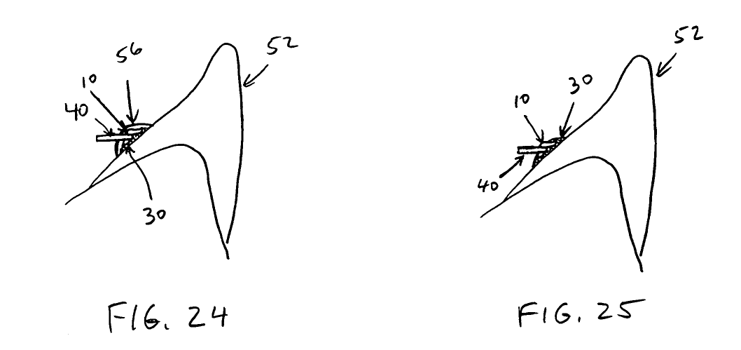

The handle portion 44 is configured for being grasped by a person's hand and/or by a positioning tool 50 (see also FIG. 18). In this way, the bracket 10 can be held in place while the orthodontist bonds it to the corresponding tooth.

In addition, the handle 44 is preferably keyed for use with a keyed positioning tool, so that the clip 40 can be consistently aligned when grasping it with the positioning tool. For example, the handle 44 may have grooves 46 on both sides for receiving one or more ridges (not shown) on the positioning tool, or vice versa, so that the clip can be flipped either side up and still aligned and centered on the positioning tool.

In alternative embodiments, the clip has a finger with a detent for holding the bracket on it, the finger is keyed for use with matingly keyed bracket openings for centering or otherwise positioning the brackets on the clip, and/or the finger has a thin liner sleeve to which the adhesive bonds so that the sleeve tears away and stays in the bracket opening when the finger is removed. And in another alternative embodiment, the clip has two fingers for use with single- or double-opening brackets.

In another aspect of the present invention, there is provided an orthodontic kit that includes a plurality of the orthodontic brackets 10 and grasping clips 40. The kit is not shown in the figures separately from its constituent parts, which are individually described and shown. Preferably, the brackets 10 and clips 40 are of the type described herein, though other brackets and/or clips can be provided.

Turning now to FIGS. 18-23, there is shown an exemplary method of attaching the brackets 10 to teeth 12 to form the attachments 14 and appliances 34. The method includes creating a model 52 of the teeth 12, which can be done by conventional techniques well known in the art, and providing orthodontic brackets 10 with openings for the wire. Preferably, brackets 10 of the type described herein are used, though others can be used to obtain some of the benefits of the method. Next, the brackets 10 are positioned relative to the model teeth 52, for example, with each bracket positioned and held by a grasping clip 40, which is moved into position and held there by a positioning tool or device 50, as shown in FIG. 18. The positioning tool or device 50 is preferably of the type disclosed in U.S. patent application Ser. No. 10/______ , filed on Dec. 31, 2003, and entitled “Orthodontic Bracket Positioning Device And Method,” which in its entirety is hereby incorporated herein by reference. Alternatively, the positioning tool or device may be of a conventional type known in the art, such as that disclosed by U.S. Pat. No. 4,812,118 to Creekmore, which in its entirety is hereby incorporated herein by reference.

The step of positioning the brackets 10 includes, for each of the brackets, positioning the bracket offset from or adjacent to the corresponding tooth 12, as is appropriate for that particular tooth, and preferably referencing relevant anatomical features of the particular tooth to determine its appropriate position and coordinating the position with other attachments of the relevant section. Also, this step may include positioning some of the brackets 10 at the lingual surfaces of the front teeth 12 and positioning some of the brackets at the facial surfaces of the back teeth 112 in an overlapping arrangement. In addition, the bracket openings are occluded to prevent the intrusion of adhesive, for example, by using a clip 40 that has a finger that inserts into the opening.

Next, the positioned bracket 10 is encapsulated and bonded to the model teeth 52 with the adhesive 30, as shown in FIG. 19. Then a transfer tray is formed around the clips 40, brackets 10, adhesive encapsulation 30, and model 52 using an impression material 54 such as a thermoplastic material, as shown in FIG. 20. Next, the transfer tray is removed. The mechanical interlocking of the tray impression material around the clips assists in breaking the bond of the adhesive to the model teeth such that the clips 40, the brackets 40, and adhesive 30 encapsulating them are removed from the model and are now contained in the impression material 54 in the tray, as shown in FIG. 21. The operator can assist breaking the bonds of the brackets to the model via insertion of an instrument underneath or through the tray material to mechanically force a breakage.

Next, the impression material/transfer tray 54, bracket 10, and adhesive encapsulation 30 are positioned on the patient's teeth 12 from which the model teeth 52 were made, as shown in FIG. 22. Then the brackets 10 are bonded to the teeth 12 using an adhesive 30 (prior applied or newly applied), which may be the same or a different type from that used to bond the brackets to the model teeth 52. The impression material/transfer tray 54 is then removed from the teeth 12, leaving the brackets, adhesive mass, and clips bonded to the teeth. The transfer tray impression material 54 can be easily pulled off the brackets 10 by hand. And the bracket openings are unoccluded, for example, by removing the clips, leaving the bracket openings unobstructed and ready to receive the wire through them. FIG. 23 shows a completed orthodontic attachment 14, with the adhesive material 30 encapsulating the bracket 10 and bonded to the tooth, while the opening is unobstructed.

An alternative method of attaching the brackets 10 to teeth 12 to form the attachments 14 and appliances 34 is similar to the exemplary method described above. In this alternative method, however, the brackets 10 are encapsulated by bonding the brackets 10 to the model teeth 52 and, instead of encapsulating them with the adhesive 30, applying removable shells 56 over the brackets, as shown in FIG. 24. The shells 56 may be plastic or made of another material with sufficient rigidity that they do not compress when the impression material is applied to it. Then an impression is made in the impression material of the shell-encapsulated bracket, the impression material and shell-encapsulated bracket are removed from the model teeth, the shell is removed from the impression material, and the void left where the shell was is now filled with the adhesive material. Using this method, the resulting low profile cap over the bracket is very smooth and uniform so to be less noticeable to the user's tongue.

Another alternative method of attaching the brackets 10 to teeth 12 to form the attachments 14 and appliances 34 is similar to the methods described above. In this alternative method, however, the brackets 10 are not encapsulated, but are merely embedded into a mass of the adhesive. In particular, after the bracket 10 is positioned relative to the model teeth 52, a mass of the adhesive 30 is applied to the model teeth and the bracket is embedded into the mass and thereby bonded to the model teeth, as shown in FIG. 24. But the bracket 10 is not covered with the adhesive or otherwise encapsulated. The resulting attachment has a lower profile because no material is applied over the lingual side of the bracket. And because the bracket 10 is embedded in the adhesive 30, that is, the bracket is sunk at least somewhat into the adhesive mass, the resulting bond is strong. Of course, the brackets can be bonded to the teeth with the adhesive only being between the bracket and the tooth, without being encapsulated or embedded into the adhesive, if that is desired in a given case.

In view of the foregoing, it will be appreciated that various aspects of the present invention provide advantages over conventional orthodontic brackets, attachments, appliances, and methods of orthodontic treatment using these elements. These advantages include, but are not limited to, the provision of a base-independent bracket system that eliminates the lever-arm effect and thereby allows for effectively unlimited customization of slot orientation while maintaining the lowest possible attachment profile.

In addition, the innovative bracket system and positioning system eliminates the need for an open-faced slot in the attachments and instead provides a bracket that is used to form an attachment with a close-faced slot. Therefore, no tie wings and thus no ligature ties are needed, so the brackets have a lower profile and are smoother. Furthermore, because closed-faced system possess limitations on the degree of wire bends that can be placed, this then requires a high degree of precision positioning of the attachments to minimize the need for such bends and thus to minimize the need for manual adjustments by the operator and thus provide for much more efficient and less costly treatment and less stress for doctor, and reduced treatment time. Moreover, the lack of tie-wings and ligature ties allows for far less friction which permits more efficient translation of forces to teeth, which in turn permits easier sliding, which results in higher efficiency.

Furthermore, aspects of the present invention provide for precise coordination of over-lapping wire segments to create a “simulated-continuous” wire system. This overcomes the problem of needing a large wire bend at the canine-premolar in the traditional lingual methods—therefore, one create a useable straight wire system on the lingual side with a minimal bracket profile height and maximum smoothness. For example, the first premolar could receive two attachments (or one double-opening attachment) on the lingual side to serve as the overlap point for creating the simulated continuous wire mechanical system. This permits the use of straight wire segments exclusively—theoretically an entire arch could be composed of multiple two-tooth segments which alternate between facial and lingual (or they could be all on the lingual or all on the facial using a double tube attachment). In addition, this permits using anterior bracket attachments on the lingual side of anterior teeth and posterior bracket attachments on the facial side of posterior teeth, with one tooth on each side being the point of overlap and having both a facial and lingual attachment. Furthermore, this permits the use of different horizontal planes for each wire segment—one can be placed higher, the other lower.

Moreover, the anterior lingual application of the attachments provides additional advantages. The anterior attachments can be placed on the lingual side of the teeth to keep them out of sight. The small profile of the attachments maintains patient comfort. And the smooth surface of the encapsulated attachments further enhance patient comfort. Finally, an appliance including the lingual and facial attachments of the size, shape, and position as proposed can be maintained in place following active therapy to serve as a semi-permanent fixed retainer. This type of fixed retainer would be unique in that the wire can be removed while leaving the attachments in place. As such, the wire can be removed to facilitate cleaning by the patient and can be replaced with a new or same wire. This type of fixed retainer would also be unique in that the same appliance serves as both the treatment mechanism and the retainer mechanism. This eliminates the need for fabrication of an additional retainer appliance at the completion of active therapy. Furthermore, any fixed type retainer has the advantage of not requiring compliance by the patient (unlike a removable retainer that requires the patient remember to wear it) and the advantage of being more comfortable and attractive than removable appliances that are visible on the facial side and generally quite bulky.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be limiting of the claimed invention. In addition, as used in the specification including the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

Moreover, while certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

The invention claimed is:

1. An orthodontic bracket for use with a wire to reposition a tooth, comprising:
a body defining a coextensive opening for receiving the wire, wherein the body does not have a base with a surface area for bonding directly to the tooth and fixing the position of the opening, wherein the bracket is positionable at an angle relative to the tooth surface without any part of the body creating a lever arm against the tooth surface.

2. The orthodontic bracket of claim 1, wherein the body comprises a gingival sidewall, an occlusal sidewall, and a lingual sidewall therebetween that cooperatively define the opening so that the opening is open on a tooth side.

3. The orthodontic bracket of claim 2, wherein the body has a low profile width that is equal to a depth of the opening plus a thickness of the lingual sidewall.

4. The orthodontic bracket of claim 2, wherein the bracket is positionable offset from the tooth or adjacent to the tooth, wherein when the bracket is offset from the tooth then no part of the bracket contacts the tooth, and when the bracket is adjacent to the tooth then the gingival sidewall, the occlusal sidewall, or both contact the tooth.

5. The orthodontic bracket of claim 2, wherein the opening is rectangular and the bracket is positionable adjacent to or offset from a vertical or a non-vertical surface of the tooth with the rectangular opening still level.

6. The orthodontic bracket of claim 5, wherein the gingival sidewall has a length that is greater than a length of the occlusal sidewall so that the open tooth side is angled from vertical.

7. The orthodontic bracket of claim 1, wherein the body comprises one or more retention wings extending therefrom.

8. The orthodontic bracket of claim 7, wherein the body has a low profile width that is equal to a depth of the opening plus a thickness of the lingual sidewall plus a horizontal extension of the wings.

9. The orthodontic bracket of claim 7, wherein the opening is rectangular and the wings are angled relative to the rectangular opening so that the bracket is positionable adjacent to or offset from a vertical or a non-vertical surface of the tooth with the rectangular opening still level.

10. The orthodontic bracket of claim 9, wherein the wings are curved away from the tooth as they extend away from the opening so that if the wings were extended across the opening they would form a continuous convex surface.

11. The orthodontic bracket of claim 10, wherein one of the wings extends from a gingival sidewall of the body and is curved back as the wing extends away from the opening, and another of the wings extends from an occusal sidewall of the body and is curved back as the wing extends away from the opening.

12. The orthodontic bracket of claim 10, wherein one of the wings extends from a gingival sidewall of the body and is curved back as the wing extends away from the opening, and another of the wings extends from an occusal sidewall of the body and is curved forward as the wing extends away from the opening.

13. The orthodontic bracket of claim 1, wherein the body defines notches arranged for enhanced bonding strength.

14. The orthodontic bracket of claim 1, wherein at least a portion of the body and the opening are curved laterally.

15. The orthodontic bracket of claim 1, wherein the body defines two or more of the openings.

16. The orthodontic bracket of claim 1, wherein the opening is tubular with open

17. An orthodontic attachment comprising a mass of adhesive bonded to the tooth and the bracket of claim 1 embedded in the adhesive mass.

18. The orthodontic attachment of claim 17, wherein the adhesive mass encapsulates the bracket except for the opening.

19. The orthodontic attachment of claim 17, wherein the adhesive mass and the bracket are attached to a lingual surface of the tooth.

20. An orthodontic appliance attached to a plurality of teeth, the appliance comprising a plurality of the attachments of claim 17, wherein at least one of the attachments is attached to a lingual surface of a front one of the teeth.

21. The orthodontic appliance of claim 20, wherein at least one other of the attachments is attached to a facial surface of a back one of the teeth.

22. An orthodontic kit comprising at least one of the brackets of claim 1 and at least one clip configured to hold the bracket during attachment.

23. The orthodontic kit of claim 22, wherein the clip comprises a finger that is receivable in the bracket opening and a handle portion for grasping.

24. A clip for holding an orthodontic bracket having an opening, the clip comprising:
a finger that is receivable in the bracket opening; and
a handle portion for grasping.

25. The clip of claim 24, wherein the finger has a cross sectional shape that conforms to a cross sectional shape of the bracket opening.

26. The clip of claim 24, wherein the finger is configured so that it is receivable in the bracket opening with a snug fit so that the clip can be held by the handle portion and the clip will support the bracket.

27. The clip of claim 24, wherein the finger has a length that is greater than a length of the bracket opening so that the finger is extendable all the way through the opening to prevent an adhesive from intruding into the opening.

28. The clip of claim 24, wherein the finger is curved.

29. The clip of claim 24, wherein the handle portion is keyed for use with a keyed positioning tool or device, wherein the clip is consistently alignable when grasped by the positioning tool or device.

30. An orthodontic attachment for use with a wire to reposition a tooth, comprising:
a mass of adhesive bonded to the tooth; and
an orthodontic bracket comprising a body at least partially defining an opening for receiving the wire, wherein the bracket is embedded in the adhesive mass.

31. The orthodontic attachment of claim 30, wherein the adhesive mass encapsulates the bracket except for the opening.

32. The orthodontic attachment of claim 30, wherein the opening is a closed tube with at least one sidewall defined by the adhesive mass.

33. The orthodontic attachment of claim 30, wherein the adhesive mass and the bracket are attached to a lingual surface of the tooth.

34. An orthodontic appliance attached to a plurality of teeth, the appliance comprising a plurality of the attachments of claim 30, wherein at least one of the attachments is attached to a lingual surface of a front one of the teeth.

35. The orthodontic appliance of claim 34, wherein at least one other of the attachments is attached to a facial surface of a back one of the teeth

36. A method of attaching orthodontic brackets to teeth, comprising:
creating a model of the teeth;
providing a plurality of orthodontic brackets each having an opening for receiving a wire;
positioning the brackets relative to the model teeth;
occluding the bracket openings;
bonding the brackets to the model teeth with an adhesive;
applying an impression material to the model teeth and the brackets;
removing the impression material and the brackets from the model teeth with the brackets held in position by the impression material;
positioning the impression material and the brackets on the teeth;
bonding the brackets to the teeth with an adhesive;
removing the impression material from the teeth; and
unoccluding the bracket opening,
wherein upon completion of the method, the adhesive is bonded to the teeth and the brackets are embedded in the adhesive with the openings unobstructed.

37. The method of claim 36, wherein the step of providing a plurality of brackets comprises providing brackets each comprising three sidewalls and an open side defining the opening, without a base with a surface area for bonding directly to the corresponding tooth, wherein the brackets are positionable at an angle relative to the corresponding tooth surface without any part of the bracket creating a lever arm against the tooth surface, the bracket has a low profile width, and the bracket is positionable offset from the tooth or adjacent to the tooth.

38. The method of claim 36, wherein the step of positioning the brackets comprises, for each of the brackets, providing a clip for holding the bracket and moving the clip until the bracket is positioned.

39. The method of claim 38, wherein, for each of the brackets, the step of occluding the bracket opening comprises inserting a finger of the clip into the bracket opening, and the step of unoccluding the bracket opening comprises removing the finger from the bracket opening.

40. The method of claim 38, wherein the step of positioning the brackets further comprises, for each of the brackets, grasping a handle portion of the clip by a positioning tool or device.

41. The method of claim 36, wherein the step of positioning the brackets comprises, for each of the brackets, suspending the bracket offset from or adjacent to the corresponding tooth.

42. The method of claim 36, wherein the step of positioning the brackets comprises, for at least one of the brackets, base-independently positioning and orienting the bracket relative to the corresponding tooth so that the bracket opening orientation is not fixed but instead is customized to the corresponding tooth for coordination with adjacent bracket openings to form a smooth and continuous arch-shaped wire pathway upon completion of the orthodontic treatment.

43. The method of claim 36, wherein the step of positioning the brackets comprises, for at least one of the brackets, positioning the bracket offset from the corresponding tooth so that the bracket is suspended in the adhesive and does not contact the tooth.

44. The method of claim 36, wherein the step of positioning the brackets comprises positioning at least one of the brackets at a lingual surface of a front one of the teeth.

45. The method of claim 44, wherein the step of positioning the brackets further comprises positioning at least one other of the brackets at a facial surface of a back one of the teeth.

46. The method of claim 45, wherein the step of positioning the brackets further comprises positioning the facial surface brackets and the lingual surface brackets in an overlapping arrangement.

47. The method of claim 45, further comprising the step of removing the facial surface brackets while leaving intact the lingual surface brackets for use as a retainer.

48. The method of claim 36, wherein:
the step of bonding the brackets to the model teeth comprises encapsulating each of the brackets; and
the step of applying an impression material to the model teeth and the brackets comprises forming an impression in the impression material of the bracket encapsulation,
wherein upon completion of the method, the brackets are encapsulated by the adhesive with the openings unobstructed.

49. The method of claim 48, wherein the step of encapsulating each of the brackets comprises covering the brackets with the adhesive.

50. The method of claim 49, wherein the step of encapsulating each of the brackets further comprises providing the adhesive in a color generally conforming to the natural color of the teeth.

51. The method of claim 48, wherein the step of encapsulating each of the brackets comprises covering each of the brackets with a corresponding shell.

52. The method of claim 51, further comprising:
removing the shells from the brackets and from the impression material; and
filling the bracket-encapsulating impression in the impression material with the adhesive.
